(19) United States
(12) Patent Application Publication
(10) Pub. No.: US 2025/0241505 A1
(43) Pub. Date: Jul. 31, 2025

(54) DISHWASHER APPLIANCE AND WINTERIZATION OPERATION FOR A DISHWASHER APPLIANCE

(71) Applicant: Haier US Appliance Solutions, Inc., Wilmington, DE (US)

(72) Inventors: Zachary Thelen, Georgetown, IN (US); Paul Newsom, Louisville, KY (US); Richard Dustin Henderson, LaGrange, KY (US)

(21) Appl. No.: 18/422,740

(22) Filed: Jan. 25, 2024

(51) Int. Cl. A47L 15/00; A47L 15/42; B60R 15/02

(52) U.S. Cl. CPC A47L 15/0018; A47L 15/4293; B60R 15/02; A47L 2301/04; A47L 2401/06; A47L 2401/09; A47L 2401/26; A47L 2501/02; A47L 2501/03; A47L 2501/05; A47L 2501/07

(57) ABSTRACT

A dishwasher appliance connected to a water supply circuit includes a tub defining a wash chamber; a pump in fluid communication with the wash chamber; a user interface comprising at least one input; and a controller operably coupled with the user interface and the pump, the controller being configured to perform a winterization operation. The winterization operation includes determining that a municipal water source has been disconnected from the water supply circuit; supplying a volume of water to the wash chamber after determining that the municipal water source has been disconnected; determining that the volume of water within the wash chamber is greater than a predetermined minimum volume of water; circulating, via the pump, the volume of water within the wash chamber for a predetermined length of time; and draining the volume of water from the wash chamber after circulating the volume of water for the predetermined length of time.

### FIELD OF THE INVENTION

The present subject matter relates generally to appliances, and more particularly to methods of operating appliances such as dishwasher appliances.

### BACKGROUND OF THE INVENTION

Dishwasher appliances generally include a tub that defines a wash chamber. Rack assemblies can be mounted within the wash chamber of the tub for receipt of articles for washing. Multiple spray assemblies can be positioned within the wash chamber for applying or directing wash liquid (e.g., water, detergent, etc.) towards articles disposed within the rack assemblies in order to clean such articles. After being applied or directed towards the rack assemblies and/or articles therein, the wash liquid generally flows by gravity to or towards a bottom of the wash chamber, such as to a sump positioned at the bottom of the wash chamber. Dishwasher appliances are also typically equipped with one or more pumps, such as a circulation pump or a drain pump, for directing or motivating wash liquid from the sump to, e.g., the spray assemblies or an area outside of the dishwasher appliance.

Some dishwasher appliances are positioned within locales that are occupied only temporarily, such as recreational vehicles (RVs), vacation homes, cabins, and the like. Accordingly, such dishwasher appliances may require winterization to avoid damage to parts (e.g., spray assemblies, etc.) within the appliance. However, existing methods present several drawbacks. For one example, residual water within the appliance is difficult to remove with air pumps. For another example, water supply circuits throughout the locale may also contain residual water.

Accordingly, a dishwasher appliance which obviates one or more of the above-mentioned drawbacks would be beneficial. In particular, a method of operating a dishwasher appliance to provide complete winterization would be useful.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a dishwasher appliance connected to a water supply circuit is provided. The dishwasher appliance may include a tub defining a wash chamber for receipt of articles for washing; a pump in fluid communication with the wash chamber; a user interface including at least one input configured to receive inputs to operate the dishwasher appliance; and a controller operably coupled with the user interface and the pump, the controller being configured to perform a winterization operation. The winterization operation may include determining that an external water source has been disconnected from the water supply circuit; supplying a volume of water to the wash chamber after determining that the external water source has been disconnected; determining that the volume of water within the wash chamber is greater than a predetermined minimum volume of water; circulating, via the pump, the volume of water within the wash chamber for a predetermined length of time; and draining the volume of water from the wash chamber after circulating the volume of water for the predetermined length of time.

In another exemplary aspect of the present disclosure, a method of operating a dishwasher appliance is provided. The dishwasher appliance may include a tub defining a wash chamber, a pump in fluid communication with the wash chamber, and a user interface including at least one input. The method may include determining that an external water source has been disconnected from the water supply circuit; supplying a volume of water to the wash chamber after determining that the external water source has been disconnected; determining that the volume of water within the wash chamber is greater than a predetermined minimum volume of water; circulating, via the pump, the volume of water within the wash chamber for a predetermined length of time; and draining the volume of water from the wash chamber after circulating the volume of water for the predetermined length of time.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a recreational vehicle according to an exemplary embodiment of the present disclosure.

FIG. 2 provides a perspective view of an exemplary embodiment of a dishwashing appliance of the present disclosure with a door in a partially open position.

FIG. 3 provides a side, cross-sectional view of the exemplary dishwashing appliance of FIG. 2.

FIG. 4 provides a flow chart illustrating a method of operating a dishwasher appliance according to exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

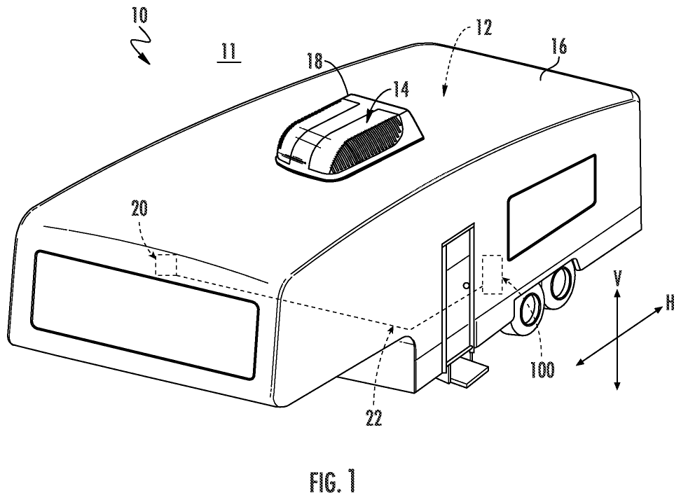

FIG. 1 provides a perspective view of an exemplary recreational vehicle (or RV) 10 in accordance with the present disclosure. People may employ RV 10 for a variety of purposes, including transportation, cooking, eating, sleeping, entertaining, and the like. As such, RV 10 defines a passenger compartment 12, which may further include a bed, stove, table, dishwasher appliance (e.g., dishwasher appliance 100, described below), restroom, or multiple compartments for storing items that passengers wish to take with them on their travels. RV 10 may further include an air conditioning system 14 including a top cover 18 mounted on an outer surface 16 thereof. Air conditioning system 14 may communicate with an outdoor environment 11 to circulate air within passenger compartment 12. RV 10 described herein is provided by way of example only, and additional or alternative elements, designs, or features may be included or excluded according to specific embodiments.

RV 10 may include a water supply circuit 22. For instance, water supply circuit 22 may be fluidly connected with, e.g., a dishwasher appliance 100 positioned within passenger compartment 12. Water supply circuit 22 may include one or more tubes, pipes, hoses, or other conduits through which water (or any suitable liquid) may be supplied to dishwasher appliance 100. In some instances, water supply circuit 22 extends throughout RV 10 (e.g., through passenger compartment 12) such that multiple appliances requiring water are attached thereto. Water supply conduit 22 may include an inlet 24. For instance, a municipal (or external) water source 20 may be connected at inlet 24 to supply water to RV 10. According to some instances, inlet 24 may be positioned distal to a location of a connected appliance, such as dishwasher appliance 100.

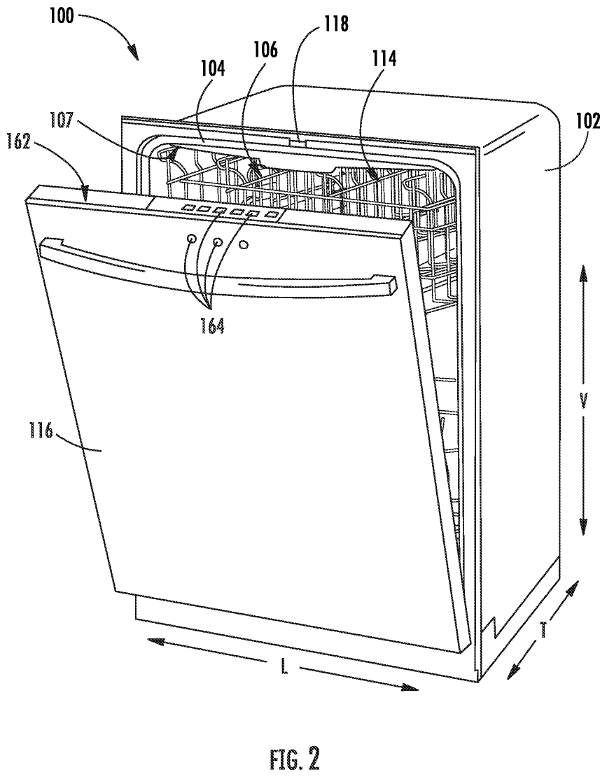

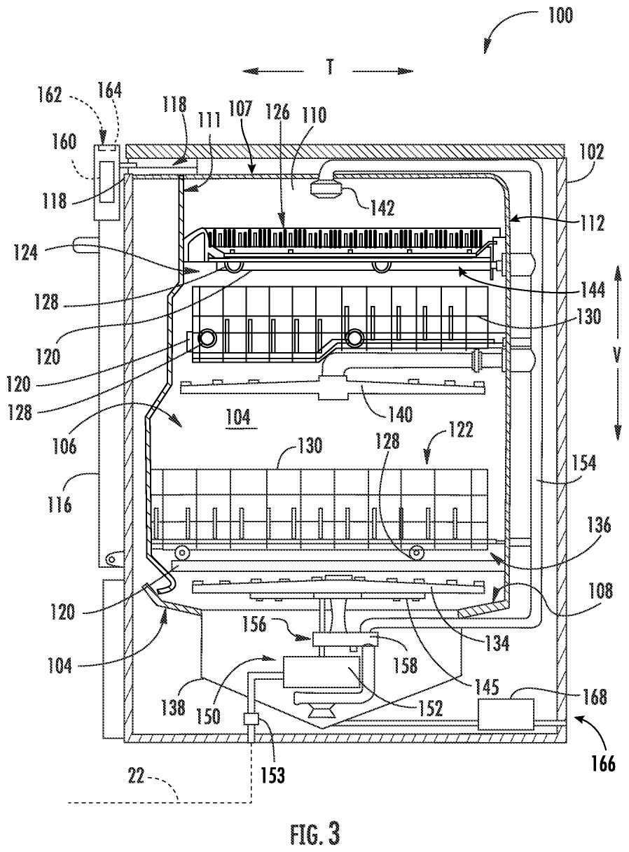

Referring now to FIGS. 2 and 3, dishwasher appliance 100 will be described in detail. For instance, FIGS. 2 and 3 depict an exemplary dishwasher or dishwashing appliance (e.g., dishwashing appliance 100) that may be configured in accordance with aspects of the present disclosure. As mentioned above, dishwasher appliance 100 may be installed within RV 10. Generally, dishwasher 100 defines a vertical direction V, a lateral direction L, and a transverse direction T. Each of the vertical direction V, lateral direction L, and transverse direction T are mutually perpendicular to one another and form an orthogonal direction system.

Dishwasher 100 includes a cabinet 102 having a tub 104 therein that defines a wash chamber 106. As shown in FIG. 2, tub 104 extends between a top 107 and a bottom 108 along the vertical direction V, between a pair of side walls 110 along the lateral direction L, and between a front side 111 and a rear side 112 along the transverse direction T.

Tub 104 includes a front opening 114 (FIG. 2). In some embodiments, the dishwasher appliance 100 may also include a door 116 at the front opening 114. The door 116 may, for example, be hinged at its bottom for movement between a normally closed vertical position, wherein the wash chamber 106 is sealed shut for washing operation, and a horizontal open position for loading and unloading of articles from dishwasher 100. A door closure mechanism or assembly 118 may be provided to lock and unlock door 116 for accessing and sealing wash chamber 106.

In exemplary embodiments, tub side walls 110 accommodate a plurality of rack assemblies. For instance, guide rails 120 may be mounted to side walls 110 for supporting a lower rack assembly 122, a middle rack assembly 124, or an upper rack assembly 126. In some such embodiments, upper rack assembly 126 is positioned at a top portion of wash chamber 106 above middle rack assembly 124, which is positioned above lower rack assembly 122 along the vertical direction V.

Generally, each rack assembly 122, 124, 126 may be adapted for movement between an extended loading position (not shown) in which the rack is substantially positioned outside the wash chamber 106, and a retracted position (shown in FIGS. 2 and 3) in which the rack is located inside the wash chamber 106. In some embodiments, movement is facilitated, for instance, by rollers 128 mounted onto rack assemblies 122, 124, 126, respectively. Although guide rails 120 and rollers 128 are illustrated herein as facilitating movement of the respective rack assemblies 122, 124, 126, it should be appreciated that any suitable sliding mechanism or member may be used according to alternative embodiments.

In optional embodiments, some or all of the rack assemblies 122, 124, 126 are fabricated into lattice structures including a plurality of wires or elongated members 130 (for clarity of illustration, not all elongated members making up rack assemblies 122, 124, 126 are shown in FIG. 2). In this regard, rack assemblies 122, 124, 126 are generally configured for supporting articles within wash chamber 106 while allowing a flow of wash liquid to reach and impinge on those articles (e.g., during a cleaning or rinsing cycle). According to additional or alternative embodiments, a silverware basket (not shown) is removably attached to a rack assembly (e.g., lower rack assembly 122), for placement of silverware, utensils, and the like, that are otherwise too small to be accommodated by the rack assembly.

Generally, dishwasher 100 includes one or more spray assemblies for urging a flow of fluid (e.g., wash liquid) onto the articles placed within wash chamber 106. In exemplary embodiments, dishwasher 100 includes a lower spray arm assembly 134 disposed in a lower region 136 of wash chamber 106 and above a sump 138 so as to rotate in relatively close proximity to lower rack assembly 122.

In additional or alternative embodiments, a mid-level spray arm assembly 140 is located in an upper region of wash chamber 106 (e.g., below and in close proximity to middle rack assembly 124). In this regard, mid-level spray arm assembly 140 may generally be configured for urging a flow of wash liquid up through middle rack assembly 124 and upper rack assembly 126.

In further additional or alternative embodiments, an upper spray assembly 142 is located above upper rack assembly 126 along the vertical direction V. In this manner, upper spray assembly 142 may be generally configured for urging or cascading a flow of wash liquid downward over rack assemblies 122, 124, and 126.

In yet further additional or alternative embodiments, upper rack assembly 126 may further define an integral spray manifold 144. As illustrated, integral spray manifold 144 may be directed upward, and thus generally configured for urging a flow of wash liquid substantially upward along the vertical direction V through upper rack assembly 126.

In still further additional or alternative embodiments, a filter clean spray assembly 145 is disposed in a lower region 136 of wash chamber 106 (e.g., below lower spray arm assembly 134) and above a sump 138 so as to rotate in relatively close proximity to a filter assembly. For instance, filter clean spray assembly 145 may be directed downward to urge a flow of wash liquid across a portion of the filter assembly or sump 138.

The various spray assemblies and manifolds described herein may be part of a fluid distribution system or fluid circulation assembly 150 for circulating wash liquid in tub 104. In certain embodiments, fluid circulation assembly 150 includes a circulation pump 152 for circulating wash liquid in tub 104. Circulation pump 152 may be located within sump 138 or within a machinery compartment located below sump 138 of tub 104.

When assembled, circulation pump 152 may be in fluid communication with an external water supply line (e.g., water supply circuit 22) and sump 138. A water inlet valve 153 may be positioned between the external water supply line and circulation pump 152 (e.g., to selectively allow water to flow from the external water supply line to circulation pump 152). Additionally or alternatively, water inlet valve 153 may be positioned between the external water supply line and sump 138 (e.g., to selectively allow water to flow from the external water supply line to sump 138). During use, water inlet valve 153 may be selectively controlled to open to allow the flow of water into dishwasher 100 and may be selectively controlled to close and thereby cease the flow of water into dishwasher 100. Further, fluid circulation assembly 150 may include one or more fluid conduits or circulation piping for directing wash fluid from circulation pump 152 to the various spray assemblies and manifolds. In exemplary embodiments, such as that shown in FIG. 3, a primary supply conduit 154 extends from circulation pump 152, along rear 112 of tub 104 along the vertical direction V to supply wash liquid throughout wash chamber 106.

In some embodiments, primary supply conduit 154 is used to supply wash liquid to one or more spray assemblies (e.g., to mid-level spray arm assembly 140 or upper spray assembly 142). It should be appreciated, however, that according to alternative embodiments, any other suitable plumbing configuration may be used to supply wash liquid throughout the various spray manifolds and assemblies described herein. For instance, according to another exemplary embodiment, primary supply conduit 154 could be used to provide wash liquid to mid-level spray arm assembly 140 and a dedicated secondary supply conduit (not shown) could be utilized to provide wash liquid to upper spray assembly 142. Other plumbing configurations may be used for providing wash liquid to the various spray devices and manifolds at any location within dishwashing appliance 100.

Each spray arm assembly 134 and 140, upper spray assembly 142, integral spray manifold 144, filter clean assembly 145, or other spray device may include an arrangement of discharge ports or orifices for directing wash liquid received from circulation pump 152 onto dishes or other articles located in wash chamber 106. The arrangement of the discharge ports, also referred to as jets, apertures, or orifices, may provide a rotational force by virtue of wash liquid flowing through the discharge ports. Alternatively, spray assemblies 134, 140, 142, 145 may be motor-driven, or may operate using any other suitable drive mechanism. Spray manifolds and assemblies may also be stationary. The resultant movement of the spray assemblies 134, 140, 142, 145 and the spray from fixed manifolds provides coverage of dishes and other dishwasher contents with a washing spray. Other configurations of spray assemblies may be used as well. For instance, dishwasher 100 may have additional spray assemblies for cleaning silverware, for scouring casserole dishes, for spraying pots and pans, for cleaning bottles, etc.

In optional embodiments, circulation pump 152 urges or pumps wash liquid (e.g., from filter assembly 210) to a diverter 156 (FIG. 3). In some such embodiments, diverter 156 is positioned within sump 138 of dishwashing appliance 100). Diverter 156 may include a diverter disk (not shown) disposed within a diverter chamber 158 for selectively distributing the wash liquid to the spray assemblies 134, 140, 142, or other spray manifolds. For instance, the diverter disk may have a plurality of apertures that are configured to align with one or more outlet ports (not shown) at the top of diverter chamber 158. In this manner, the diverter disk may be selectively rotated to provide wash liquid to the desired spray device.

In exemplary embodiments, diverter 156 is configured for selectively distributing the flow of wash liquid from circulation pump 152 to various fluid supply conduits—only some of which are illustrated in FIG. 3 for clarity. In certain embodiments, diverter 156 includes four outlet ports (not shown) for supplying wash liquid to a first conduit for rotating lower spray arm assembly 134, a second conduit for supplying wash liquid to filter clean assembly 145, a third conduit for spraying an auxiliary rack such as the silverware rack, and a fourth conduit for supply mid-level or upper spray assemblies 140, 142 (e.g., primary supply conduit 154).

Dishwasher appliance 100 may include a drain pump 168. For instance, drain pump 168 may be positioned adjacent to sump 138. According to some embodiments, drain pump 168 is separate from circulation pump 152. However, it should be understood that in certain circumstances drain pump 168 and circulation pump 152 are the same pump. For instance, a single pump (e.g., circulation pump 152) may be configured to perform each of a circulation operation of circulating liquid (e.g., water) throughout wash chamber 106 and a draining operation of draining the liquid from wash chamber 106.

In certain embodiments, dishwasher 100 includes a controller 160 configured to regulate operation of dishwasher 100 (e.g., initiate one or more wash operations). Controller 160 may include one or more memory devices and one or more microprocessors, such as general or special purpose microprocessors operable to execute programming instructions or micro-control code associated with a wash operation that may include a wash cycle, rinse cycle, or drain cycle. The memory may represent random access memory such as DRAM, or read only memory such as ROM or FLASH. In some embodiments, the processor executes programming instructions stored in memory. The memory may be a separate component from the processor or may be included onboard within the processor. Alternatively, controller 160 may be constructed without using a microprocessor, e.g., using a combination of discrete analog or digital logic circuitry—such as switches, amplifiers, integrators, comparators, flip-flops, AND gates, and the like—to perform control functionality instead of relying upon software. It should be noted that controllers as disclosed herein are capable of and may be operable to perform any methods and associated method steps as disclosed herein.

Controller 160 may be positioned in a variety of locations throughout dishwasher 100. In optional embodiments, controller 160 is located within a control panel area 162 of door 116 (e.g., as shown in FIGS. 1 and 2). Input/output (“I/O”) signals may be routed between the control system and various operational components of dishwasher 100 along wiring harnesses that may be routed through the bottom of door 116. Typically, the controller 160 includes a user interface panel/controls 164 through which a user may select various operational features and modes and monitor progress of dishwasher 100. In some embodiments, user interface 164 includes a general purpose I/O (“GPIO”) device or functional block. In additional or alternative embodiments, user interface 164 includes input components, such as one or more of a variety of electrical, mechanical or electro-mechanical input devices including rotary dials, push buttons, and touch pads. In further additional or alternative embodiments, user interface 164 includes a display component, such as a digital or analog display device designed to provide operational feedback to a user. When assembled, user interface 164 may be in operative communication with the controller 160 via one or more signal lines or shared communication busses.

It should be appreciated that the invention is not limited to any particular style, model, or configuration of dishwasher 100. The exemplary embodiments depicted in FIGS. 1 through 3 are for illustrative purposes only. For instance, different locations may be provided for user interface 164, different configurations may be provided for rack assemblies 122, 124, 126, different spray assemblies 134, 140, 142 and spray manifold configurations may be used, different sensors may be used, such as an optical level sensor which may, in some embodiments, also be configured to measure turbidity, and other differences may be applied while remaining within the scope of the present disclosure.

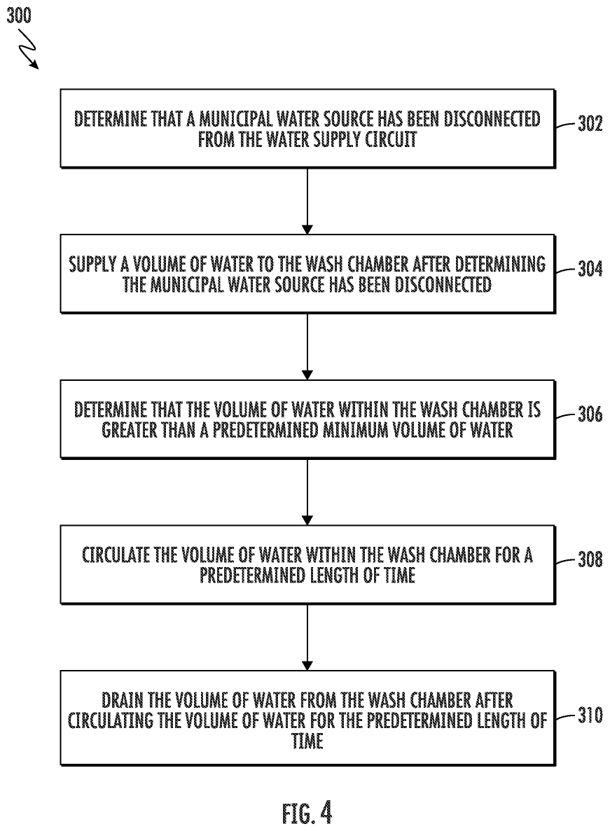

Now that the general descriptions of an exemplary appliance have been described in detail, a method 300 of operating an appliance (e.g., dishwasher appliance 100) will be described in detail. Although the discussion below refers to the exemplary method 300 of operating dishwasher appliance 100, one skilled in the art will appreciate that the exemplary method 300 is applicable to any suitable domestic appliance capable of performing a washing or water circulating operation (e.g., such as a washing machine, a beverage dispenser, etc.). In exemplary embodiments, the various method steps as disclosed herein may be performed by controller 160 and/or a separate, dedicated controller. FIG. 4 provides a flow chart illustrating a method of operating a dishwasher appliance. Hereinafter, method 300 will be described with specific reference to FIG. 4. For instance, method 300 may be applicable to a dishwasher appliance positioned in a location suited for a winterization (e.g., such as RV 10, a vacation home, etc.). Thus, method 300 may be referred to as a winterization operation.

According to some embodiments, the winterization operations may be initiated by a user via a user interface. For instance, the winterization operation may commence upon a press of a button on the dishwasher appliance. At step 302, method 300 may include determining that a municipal water source has been disconnected from a water supply circuit. In detail, as mentioned above, the dishwasher appliance may be provided in a recreational vehicle, such as an RV, a trailer, or the like. The vehicle may selectively connect to an outside or external water source, such as municipal water source 20. At certain times (e.g., when moving the RV, winterizing the RV, winterizing a vacation home, etc.), the water supply circuit may be disconnected from the water source. One or more sensors may be included (e.g., at the input for the water supply circuit) to determine when the municipal water source is disconnected. Additionally or alternatively, a user may provide an input to the dishwasher appliance indicating that the water source has been disconnected.

The user may then close and latch a door to the dishwasher appliance. In some instances, the door is closed and latched prior to disconnecting the water source. Thus, method 300 may include determining that the door is in a closed and latched position. One or more door sensors may be provided at or near the latch of the door to determine whether the door is in the closed and latched position. Additionally or alternatively, a user may provide an input to the dishwasher appliance indicating that the door is closed and latched.

At step 304, method 300 may include supplying a volume of water to the wash chamber after determining that the municipal water source has been disconnected. As mentioned previously, the dishwasher appliance may be selectively fluidly connected to the municipal water source via the water supply circuit. The water supply circuit may extend a predetermined length within the locale in which the dishwasher appliance is housed (e.g., through the RV, through a house, etc.). Accordingly, after the municipal water source is disconnected, water may remain within the water supply circuit (e.g., within pipes, valves, tubes, etc.). Thus, supplying the water to the wash chamber may include pumping (e.g., via a supply pump, a circulation pump, etc.) the remaining water within the water supply circuit into the wash chamber. Additionally or alternatively, the volume of water supplied may be less than a predetermined maximum volume. The predetermined maximum volume may be set such that the appliance does not flood. Accordingly, the predetermined maximum volume may vary according to specific units.

At step 306, method 300 may include determining that the volume of water within the wash chamber is greater than a predetermined minimum volume of water. The dishwasher appliance may include one or more means for determining a volume, amount, or quantity of water (or liquid) within the wash chamber. For instance, a level sensor, a weight sensor, an optical sensor, a flow meter, or the like may be included to determine the volume of water supplied to the wash chamber. The determined volume of water may be compared against a predetermined minimum volume of water. For instance, the predetermined minimum volume of water may be a volume of water required to circulate the water throughout the wash chamber. The minimum volume of water may be set such that the pump is not subject to cavitation while circulating the water. For some embodiments, the predetermined minimum volume of water may be between about 0.3 gallons and about 0.6 gallons. However, it should be understood that that the predetermined minimum volume of water may be any suitable amount and the disclosure is not limited to the examples provided herein.

After supplying the volume of water to the wash chamber and determining the volume supplied, method 300 may determine that the volume is less than the predetermined minimum volume of water. Method 300 may determine that the volume of water is insufficient to properly circulate through the wash chamber. At this point, method 300 may not proceed to step 308. For instance, method 300 may determine whether a user has canceled the winterization operation. According to some embodiments, method 300 may receive an input signal (e.g., from the user interface of the appliance). The input signal may include a command to cancel or end the winterization operation. Upon determining that the input to cancel the winterization operation has been received after determining that the volume of water is less than the predetermined minimum volume of water, method 300 may drain (e.g., by activating the pump) the volume of water from the wash chamber (e.g., without circulating the water) and end the operation. Otherwise, method 300 may proceed to step 308.

At step 308, method 300 may include circulating the volume of water within the wash chamber for a predetermined length of time. In detail, upon determining that the volume of water is greater than the predetermined minimum volume of water, method 300 may initiate a circulation phase for the volume of water. The circulation phase may be similar to a circulation phase for a washing operation. Thus, the water may be circulated through one or more of the spray arm assemblies. Thus, a pump (e.g., the circulation pump) may be activated for the predetermined length of time to circulate the water throughout the fixtures (e.g., spray arms, jets, etc.) within the wash chamber.

The volume of water may be circulated for a predetermined length of time. For instance, the predetermine length of time may be between about 10 seconds and about 2 minutes. However, it should be noted that the predetermine length of time may be any suitable length of time and the disclosure is not limited to the examples provided herein. After circulating the water within the wash chamber for the predetermined length of time, method 300 may proceed to step 310.

At step 310, method 300 may include draining the volume of water from the wash chamber after circulating the volume of water for the predetermined length of time. In detail, after thoroughly circulating the volume of water through the wash chamber, method 300 may activate the pump (e.g., the drain pump) to drain the volume of water. The volume of water may thus be drained either externally from the locale (e.g., RV, house, etc.) or may be drained into a receptacle, such as a drum, pan, tray, or the like.

Collectively, step 304 of supplying the volume of water to the wash chamber, step 308 of circulating the volume of water, and step 310 of draining the volume of water may constitute a cycle of the winterization operation. Multiple cycles of the winterization operation may be performed. For instance, method 300 may be repeated. As mentioned above, the water supply conduit may contain excess water requiring multiple cycles of the winterization operation to properly and fully flush the water supply conduit. Thus, method 300 may perform multiple cycles until the volume of water within the wash chamber is determined to be less than the predetermined minimum volume of water. According to some embodiments, a predetermined maximum number of cycles may be provided for which the winterization operation may be performed before being stopped. For example, the winterization operation may perform a maximum of 3 cycles, 4 cycles, 5 cycles, or the like before automatically cancelling the operation. At this point, method 300 may, in some instances, drain the remaining volume of water from the wash chamber.

According to some embodiments, method 300 may include supplying a first volume of antifreeze to the dishwasher appliance. The antifreeze may be supplied to the wash chamber after determining that the volume of water within the wash chamber is less than the predetermined minimum volume. For instance, the antifreeze may be supplied to the volume of water that remains within the wash chamber of the dishwasher appliance. Additionally or alternatively, the remaining volume of water may be drained from the wash chamber before the antifreeze is added. In some instances, the antifreeze is connected at the inlet to the water supply circuit (e.g., at an outside of the RV). Thus, the antifreeze may be pumped into the wash chamber through the water supply circuit. Advantageously, the water supply circuit may be coated with the antifreeze as it flows into the wash chamber. Additionally or alternatively, the antifreeze may be manually supplied to the appliance. For instance, a user may supply the antifreeze to the wash chamber (e.g., through the door of the appliance).

In some instances, the winterization operation may pause after determining that the volume of water within the wash chamber is less than the predetermined minimum volume of water. For instance, the pump may be maintained in an inactive or off state. At this point, method 300 may initiate the supply of antifreeze to the appliance (e.g., as described above). According to some embodiments, the pump may be maintained in the inactive state (e.g., the winterization operation remains paused) while waiting for an input signal. The input signal may be received via the user interface panel. Thus, the input signal may include a command to continue the winterization operation.

According to some embodiments, method 300 may include pulsing (e.g., selectively opening) a water valve (e.g., water inlet valve 153) according to a predetermined pattern after determining that the volume of water within the wash chamber is less than the predetermined minimum volume of water. For instance, the water valve may be repeatedly opened and closed to intermittently permit or restrict water from entering the appliance. The water valve may be pulsed to detect a flow of liquid into the wash chamber. For instance, the water valve may be pulsed while the antifreeze is being supplied to the wash chamber (e.g., via the pump). Thus, as the water valve is pulsed (e.g., cyclically at predetermined intervals), the antifreeze may collect within the appliance.

Upon determining that the flow (e.g., of antifreeze) is present within the appliance, method 300 may confirm that the first volume of antifreeze is within the wash chamber. For instance, one or more measuring devices (e.g., as mentioned above) may be utilized to determine the first volume of antifreeze. Additionally or alternatively, method 300 may receive the input signal including the command to continue the winterization operation. Accordingly, method 300 may include circulating the first volume of antifreeze within the wash chamber for a predetermined length of time. As mentioned above, the circulating of the antifreeze may be performed by the pump (e.g., circulation pump). For instance, circulating the antifreeze may include activating (or pulsing) the pump for one or more pulse periods. Moreover, the predetermined length of time may be equal to the predetermined length of time mentioned above (e.g., between about 10 second and about 2 minutes).

After circulating the antifreeze, method 300 may include draining the first volume of antifreeze from the wash chamber. As mentioned above, the draining may include activating the pump (e.g., the drain pump) to drain the first volume of antifreeze. The first volume of antifreeze may thus be drained either externally from the locale (e.g., RV, house, etc.) or may be drained into a receptacle, such as a drum, pan, tray, or the like. In some embodiments, the supplying of antifreeze, circulating the antifreeze, and draining the antifreeze is repeated a predetermined number of times (e.g., cycles). Advantageously, the appliance, including circulation pipes, tubes, and conduits may receive a coating of antifreeze. Upon determining that a most recent fill of antifreeze is less than a predetermined minimum volume of antifreeze, the winterization operation may end by draining the remaining volume of antifreeze form the appliance.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A dishwasher appliance connected to a water supply circuit, the dishwasher appliance comprising:
a tub defining a wash chamber for receipt of articles for washing;
a pump in fluid communication with the wash chamber;
a user interface comprising at least one input configured to receive inputs to operate the dishwasher appliance; and
a controller operably coupled with the user interface and the pump, the controller being configured to perform a winterization operation, the winterization operation comprising:
determining that an external water source has been disconnected from the water supply circuit;
supplying a volume of water to the wash chamber after determining that the external water source has been disconnected;
determining that the volume of water within the wash chamber is greater than a predetermined minimum volume of water;
circulating, via the pump, the volume of water within the wash chamber for a predetermined length of time; and
draining the volume of water from the wash chamber after circulating the volume of water for the predetermined length of time.

2. The dishwasher appliance of claim 1, wherein the winterization operation further comprises:
determining that the volume of water within the wash chamber is less than the predetermined minimum volume of water after supplying the volume of water to the wash chamber; and
draining the volume of water from the wash chamber without circulating the volume of water.

3. The dishwasher appliance of claim 1, wherein the winterization operation further comprises:
supplying a first volume of antifreeze to the dishwasher appliance after draining the volume of water from the wash chamber;
circulating, via the pump, the first volume of antifreeze within the wash chamber for the predetermined length of time, wherein circulating the first volume of antifreeze comprises activating the pump for one or more pulse periods; and
draining the first volume of antifreeze from the wash chamber after circulating the first volume of antifreeze for the predetermined length of time.

4. The dishwasher appliance of claim 1, wherein the supplying the volume of water, circulating the volume of water, and draining the volume of water collectively defines a cycle, and wherein the winterization operation further comprises:
determining that a number of cycles is equal to a predetermined threshold number of cycles; and
terminating the winterization operation.

5. The dishwasher appliance of claim 1, wherein the winterization operation further comprises:
determining that the volume of water within the wash chamber is less than the predetermined minimum volume of water after supplying the volume of water to the wash chamber;
initiating a supply of antifreeze to the wash chamber after determining that the volume of water within the wash chamber is less than the predetermined minimum volume of water; and
activating the pump according to a predetermined pulsing pattern after initiating the supply of antifreeze to the wash chamber.

6. The dishwasher appliance of claim 1, wherein the winterization operation further comprises:
determining that the volume of water within the wash chamber is less than the predetermined minimum volume of water after supplying the volume of water to the wash chamber; and
receiving an input via the user interface after determining that the volume of water within the wash chamber is less than the predetermined minimum volume of water.

7. The dishwasher appliance of claim 6, wherein the input comprises a command to end the winterization operation, and wherein the winterization operation further comprises:
directing the pump to drain a fluid from the wash chamber after receiving the input, wherein the fluid contains a mixture of water and antifreeze.

8. The dishwasher appliance of claim 6, wherein the input comprises a command to continue to the winterization operation, and wherein the winterization operation further comprises:
supplying a first volume of antifreeze to the dishwasher appliance after draining the volume of water from the wash chamber;
circulating, via the pump, the first volume of antifreeze within the wash chamber for the predetermined length of time; and
draining the first volume of antifreeze from the wash chamber after circulating the first volume of antifreeze for the predetermined length of time.

9. The dishwasher appliance of claim 1, further comprising a door movable between a latched position and an open position, wherein the winterization operation further comprises:
determining that the door is in the latched position prior to supplying the volume of water to the wash chamber.

10. The dishwasher appliance of claim 1, wherein the dishwasher appliance is positioned within a recreational vehicle.

11. A method of operating a dishwasher appliance, the dishwasher appliance being coupled to a water supply circuit, the dishwasher appliance comprising a tub defining a wash chamber, a pump in fluid communication with the wash chamber, and a user interface comprising at least one input, the method comprising:
determining that an external water source has been disconnected from the water supply circuit;
supplying a volume of water to the wash chamber after determining that the external water source has been disconnected;
determining that the volume of water within the wash chamber is greater than a predetermined minimum volume of water;
circulating, via the pump, the volume of water within the wash chamber for a predetermined length of time; and
draining the volume of water from the wash chamber after circulating the volume of water for the predetermined length of time.

12. The method of claim 11, further comprising:
determining that the volume of water within the wash chamber is less than the predetermined minimum volume of water after supplying the volume of water to the wash chamber; and
draining the volume of water from the wash chamber without circulating the volume of water.

13. The method of claim 11, further comprising:
supplying a first volume of antifreeze to the dishwasher appliance after draining the volume of water from the wash chamber;
circulating, via the pump, the first volume of antifreeze within the wash chamber for the predetermined length of time, wherein circulating the first volume of antifreeze comprises activating the pump for one or more pulse periods; and
draining the first volume of antifreeze from the wash chamber after circulating the first volume of antifreeze for the predetermined length of time.

14. The method of claim 11, wherein the supplying the volume of water, circulating the volume of water, and draining the volume of water collectively defines a cycle of a winterization operation, and wherein the method further comprises:
determining that a number of cycles is equal to a predetermined threshold number of cycles; and
terminating the winterization operation.

15. The method of claim 14, further comprising:
determining that the volume of water within the wash chamber is less than the predetermined minimum volume of water after supplying the volume of water to the wash chamber;
initiating a supply of antifreeze to the wash chamber after determining that the volume of water within the wash chamber is less than the predetermined minimum volume of water; and
activating the pump according to a predetermined pulsing pattern after initiating the supply of antifreeze to the wash chamber.

16. The method of claim 14, further comprising:
determining that the volume of water within the wash chamber is less than the predetermined minimum volume of water after supplying the volume of water to the wash chamber; and
receiving an input via the user interface after determining that the volume of water within the wash chamber is less than the predetermined minimum volume of water.

17. The method of claim 16, wherein the input comprises a command to end the winterization operation, and wherein the method further comprises:
directing the pump to drain a fluid from the wash chamber after receiving the input, wherein the fluid contains a mixture of water and antifreeze.

18. The method of claim 16, wherein the input comprises a command to continue to the winterization operation, and wherein the method further comprises:
supplying a first volume of antifreeze to the dishwasher appliance after draining the volume of water from the wash chamber;
circulating, via the pump, the first volume of antifreeze within the wash chamber for the predetermined length of time; and
draining the first volume of antifreeze from the wash chamber after circulating the first volume of antifreeze for the predetermined length of time.

19. The method of claim 11, further comprising a door movable between a latched position and an open position, wherein the method further comprises:
determining that the door is in the latched position prior to supplying the volume of water to the wash chamber.

20. The dishwasher appliance of claim 1, wherein the dishwasher appliance is positioned within a recreational vehicle.
